(19) United States
(12) Patent Application Publication
(10) Pub. No.: US 2012/0151413 A1
(43) Pub. Date: Jun. 14, 2012

(54) METHOD AND APPARATUS FOR PROVIDING A MECHANISM FOR PRESENTATION OF RELEVANT CONTENT

(75) Inventors: Mikko Antero Nurmi, Tampere (FI); Jouni Tapio Solismaa, Tampere (FI)

(73) Assignee: Nokia Corporation

(21) Appl. No.: 12/963,094

(22) Filed: Dec. 8, 2010

(51) Int. Cl. G06F 3/048; G06F 3/041

(52) U.S. Cl. 715/825; 345/173

(57) ABSTRACT

A method for providing a mechanism by which relevant content can be determined and/or presented may include receiving an indication of a touch event at a touch screen display, determining context information associated with a device employing the touch screen display, determining relevancy information for a plurality of content items based on the context information, and causing provision of a set of relevant content items according to a selected presentation paradigm based on the relevancy information. A corresponding apparatus and computer program product are also provided.

### TECHNOLOGICAL FIELD

Some example embodiments of the present invention relate generally to user interface technology and, more particularly, relate to a method and apparatus for providing a mechanism by which relevant content can be determined and/or presented.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, electronic book or reading device, etc.

In many situations, it may be desirable for the user to interface with a device such as a mobile terminal for the provision of an application or service. A user's experience during certain applications such as, for example, web browsing or navigating through content may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays. As such, touch screen devices are now relatively well known in the art, with numerous different technologies being employed for sensing a particular point at which an object may contact the touch screen display.

### BRIEF SUMMARY

A method, apparatus and computer program product are provided to enable the provision of a display of relevant content based on context information associated with a user terminal. In some cases, the context information may be provided based on other devices, on earlier device usage, or the location of the user terminal or responsive to a touch event identifying a content item having a feature or characteristic that is used as the basis for a relevancy determination.

Some embodiments of the invention may provide a method, apparatus and computer program product for improving user experience relating to devices having touch screen interfaces. As a result, for example, mobile terminal users may enjoy improved capabilities with respect to content navigation and other services or applications that may be used in connection with a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism by which relevant content can be determined and/or presented according to an example embodiment of the present invention;

FIG. 3, which includes FIGS. 3A and 3B, illustrates an example of uneven zooming as a selected presentation paradigm according to an example embodiment of the present invention;

FIG. 4, which includes FIGS. 4A and 4B, illustrates an alternative embodiment in which relevant images to a reference content item may be presented or revealed in proximity to the reference content item in response to a touch event selecting the reference content item according to an example embodiment of the present invention;

FIG. 5 shows a reference image having two different individuals therein in which selection of either individual provides a collage of images relevant to the selected individual according to an example embodiment of the present invention;

FIG. 6 shows selection of an object in a reference image to provide a collage of images relevant to the object in the reference image according to an example embodiment of the present invention; and

FIG. 7 is a block diagram according to an example method for providing a mechanism by which relevant content can be determined and/or presented according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments of the present invention may relate to the provision of content that is relevant to a feature or characteristic of a content item selected based on a touch event (e.g., a pinch or pinch out event). In some cases, a touch event may identify a reference content item (e.g., an image, video, song, album, document, message or other digital content/or object like application icon, button linked with certain functionality). Thus, for example, some embodiments may enable sorting of content items based on relevancy and/or sorting of a set of icons and/or buttons with corresponding actions. A characteristic or feature of the reference content item (e.g., the author, artist, genre, subject, picture taker, time taken/created, objects in picture, location, etc.) may provide context information to be used as a basis for identifying other relevant content items associated with the reference content item. The other relevant content items may be presented in some manner for possible selection by a user. The selection options for the other relevant content may include, for example, uneven zooming of content items based on relevancy or the selection of additional content items (e.g., as a collage) in association with the reference content item in response to the additional content items being determined to have relevance to the reference content item. Accordingly, some example embodiments may not merely be used to provide access to content associated with the reference content item, but may highlight or otherwise present the content items that are determined to be relevant in a unique way.

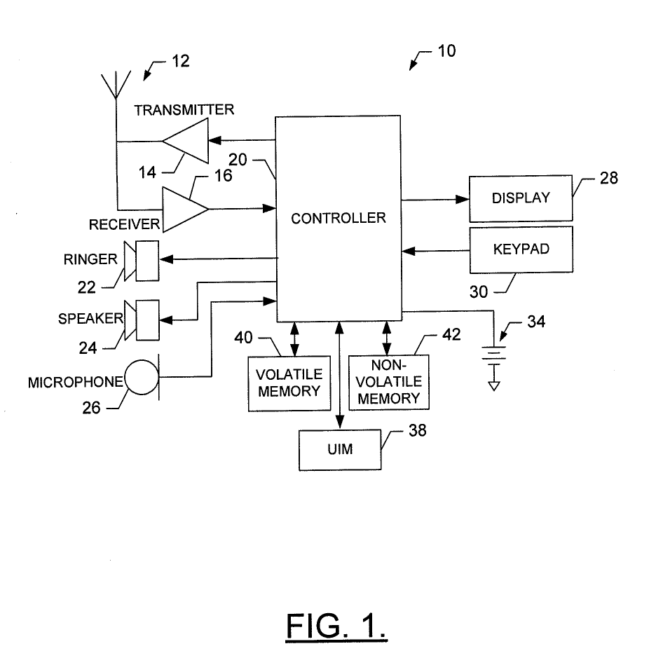

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

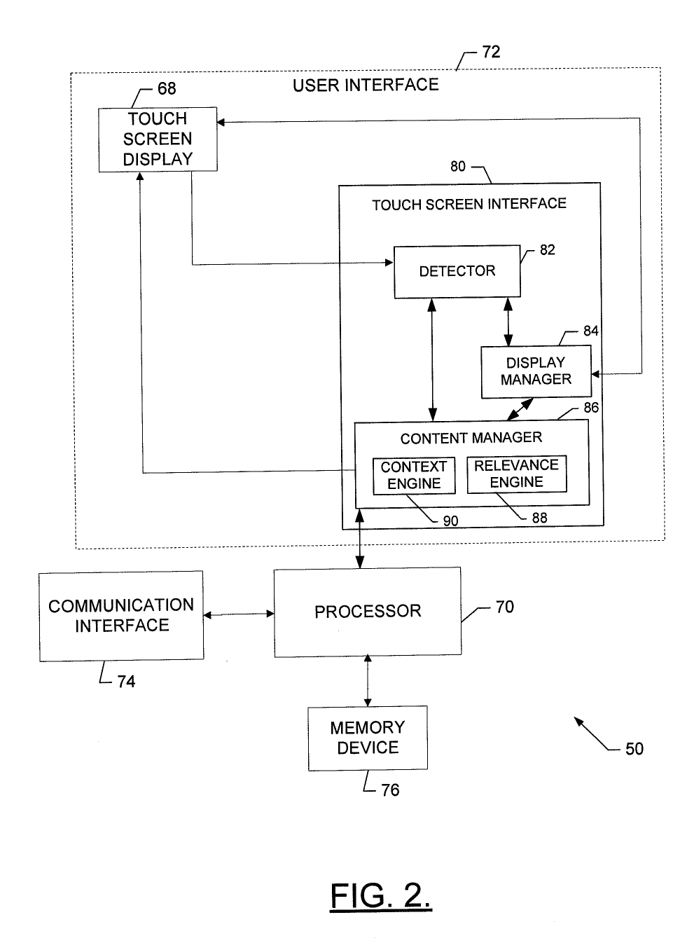

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for providing a mechanism by which relevant content may be determined and/or presented are displayed. The apparatus 50 of FIG. 2 may be employed, for example, in conjunction with the mobile terminal 10 of FIG. 1. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for providing a mechanism by which relevant content may be determined and/or presented, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for providing a mechanism by which relevant content may be determined and/or presented is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. Thus, for example, for autostrereoscopic displays, relevant content may be lifted to the front of the display and irrelevant content may be moved to the back so that user may get the feeling of items getting closer or more faraway. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector.

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84 and a device unlock manager 86. Each of the detector 82, the display manager 84 and the device unlock manager 86 may be any device or means embodied in either hardware or a combination of hardware and software configured to perform the corresponding functions associated with the detector 82, the display manager 84 and the device unlock manager 86, respectively, as described herein. In an exemplary embodiment, each of the detector 82, the display manager 84 and the device unlock manager 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area or the detection of a change in the electrostatic field of the touch screen display 68 at a particular location. As such, some touch events may not actually require physical contact with the touch screen display 68. For example, in some cases, the touch screen display 68 may be configured to detect one or more objects (e.g., a finger or fingers) hovering over the touch screen display 68. Gestures associated with the object or objects may also be detected in some cases, even without physical contact with the touch screen display 68. Subsequent to each touch event, the detector 82 may be further configured to recognize and/or determine a corresponding classification of the event. In other words, the detector 82 may be configured to classify the touch event as any of a number of possible gestures. Some examples of recognizable gestures may include a touch, multi-touch, stroke, character, pinch event (e.g., a pinch in or pinch out) and/or the like.

A touch may be defined as a touch event that impacts a single area (without or with minimal movement on the surface of the touch screen display 68) and then is removed. A multi-touch may be defined as multiple touch events sensed at the same time (or nearly the same time). A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects, one or more of the objects may move substantially toward each other to simulate a pinch. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other. In some examples, the objects associated with causing the multi-touch event may be spaced apart by any initial distance so long as the subsequent movement of the objects is in a direction apart from each other. In some cases, the detector 82 may be further enabled to determine characteristics regarding the touch events (e.g., length of time of a touch event, pressure of touch event(s), length of movement, direction of movement and/or speed of movement of the object). As such, the detector 82 may classify the touch events relative to various thresholds or ranges of lengths (in terms of time and distance), directions and/or speeds of movement. Touch events such as pinch gestures may be performed as a single continuous gesture in some cases. However, in alternative embodiments, the user may make successive short pinch gestures after each other to have same effect a single longer pinch gesture.

In an example embodiment, the detector 82 may be configured to communicate detection information regarding the recognition, detection and/or classification of a touch event to the display manager 84 and/or the content manager 86. The display manager 84 may be configured to provide control over modifications made to that which is displayed on the touch screen display 68 based on the detection information received from the detector 82. Meanwhile, the content manager 86 may be configured to provide control selection of content to be displayed and the manner in which the selected content is displayed by the display manager 84 responsive to a touch event identifying a reference content item.

In an example embodiment, the content manager 86 may include a relevance engine 88 and a context engine 90. The relevance engine 88 and the context engine 90 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the relevance engine and the context engine 90, respectively, as described herein. Thus, in examples in which software is employed, a device or circuitry (e.g., the processor 70 in one example) executing the software forms the structure associated with such means. As such, in some embodiments, the processor 70 may embody the relevance engine 88 and/or the context engine 90 and may be said to cause the corresponding functions of the relevance engine 88 and/or the context engine 90, respectively, to be performed.

In an example embodiment, the context engine 90 may be configured to repeatedly or continuously scan or otherwise receive indications of conditions relative to a context of the mobile terminal 10. The context of the mobile terminal 10 may be indicative of a current disposition of the user of the mobile terminal 10 or at least a disposition of the mobile terminal 10. For example, the context engine 90 may monitor resources of the mobile terminal 10 to determine a device state or current applications and/or content items that are active (e.g., chatting or other social activities, consuming digital media such as listening to music, reading a book, reviewing or modifying a document, reviewing or modifying images, watching a video, etc.). In some embodiments, information may be monitored and stored about earlier used applications, communication events, content items etc. The information may be referred to as context history. In some cases, physical context (e.g., what is in the surroundings of the device/user, who are the people nearby, important places nearby, objects nearby, etc.) may also be considered. Moreover, context information may also be obtained by measuring user's biosignals like heart rate, blood pressure, EEG (electroencephalography), EMG (electromyography) and also other brain related signals.

Context is generally defined as any information that can be used to characterize the situation of an entity. An entity may be a person, place or object (e.g., the user or the user's mobile terminal) that is considered relevant to an interaction between a user and an application, including the user and the application themselves. Accordingly, a system may be considered context aware if the system uses context information to provide relevant information and/or services to the user such as where relevancy depends on the user's task.

In some embodiments, the context engine 90 may be a context aware device or element configured to request context information or provide interface elements aimed at acquiring context information from the user. For example, the context engine 90 may be configured to generate various domains, fields, user interface elements and/or the like designed to enable the user to enter information that may provide context related information. The domains, fields, user interface elements and/or the like may be text entry based, predetermined selectable options, or customizable options that may change dependent upon user criteria. As an example, the context engine 90 may have a mechanism by which the user may enter the city, country, region, or specific location in which the user is located or to which a particular query pertains. As another example, various selectable common classifications for questions may be provided (e.g., weather conditions, dining, night life, tourism, driving conditions, crowd conditions, best route, recommendations, and/or many others). The information provided by the user may then be utilized to extract context information for provision to the relevance engine 88.

In an alternative embodiment, the context engine 90 may be configured to extract information from communications received (e.g., at the mobile terminal 10). As such, for example, the context may be determined from the status of applications on the mobile terminal 10, the location of the mobile terminal 10, a determination of a predefined association for a particular object, or any other mechanism for discovering the types of context information described herein. For example, the context engine 90 may request or otherwise acquire information regarding a location of the mobile terminal 10 (e.g., from the mobile terminal 10 or from a network position determining entity) and/or other communication devices. Alternatively or additionally, the context engine 90 may parse communications or metadata associated with content items (e.g., recently created content items) to determine if context information is provided within the text of the communications or within the metadata. For example, if a text message to a friend asks whether it is currently windy in Chicago, the context engine 90 may determine a location context corresponding to Chicago and a question classification context of a weather related question based on the reference to wind conditions. Context information may also be determined, for example, based on a determination of various context parameters that may be accessed by the context engine 90 in order to determine context of subscribers to the service.

Context parameters may include parameters related to, for example, environmental context, social context, spatio-temporal context, task context, terminal context, service context, access context, and/or the like. Environmental context may describe the entities around the user (e.g., the user of an electronic device) and the environment in which the user and the user's device are located. Social context may include information about relationships with other individuals (e.g., friends, relatives, co-workers, etc.). Spatio-temporal context may define the user's location (e.g., physical or geographical location) in the real world at a certain point in time. Task context may describe information related to on-going tasks. Task context may be determined, for example, from calendar applications or the execution of other applications at a particular time. Terminal context may be related to or descriptive of the status and/or capabilities of the user's device. Service context may relate to or be descriptive of services that are available at a particular location or based on the subscription level of the user. Access context may describe the status of network connectivity. In an exemplary embodiment, context parameters relating to members of the social network and/or subscribers to a question answering service may be reported to the context engine 90 or a repository accessible to the context determiner either continuously, when requested, or at random or predetermined intervals. Thus, the context engine 90 can report on context information for any user and/or for questions originating from any user, at any given time.

In an example embodiment, the context information may define at least one feature or characteristic of that can be associated with a reference content item and that correlates to a corresponding characteristic associated with a current disposition of the user of the mobile terminal 10. For example, if the user performs a touch event (e.g., a pinch event) with respect to a particular content item that is considered a reference content item, one characteristic that may be selected as context information may be the current location of the user when the reference content item is selected, the frequency (or infrequency) or accessing the reference content item, the historical times or situations in which the reference content item is typically accessed, the subject of the reference content item, an object or person in or that created the reference content item, a color, genre or classification of an object associated with the reference content item, a quality level of the reference content item, and/or the like.

After the context engine 90 has determined the context information, the context engine 90 may communicate the context information to the relevance determiner 88. The relevance determiner 88 may be configured to determine the relevance of various content items to the reference content item. As such, for example, the relevance determiner 88 may be configured to compare a plurality of content items to the reference content item to determine a degree of relevance of each of the plurality of content items. In some cases, determining relevancy information may include determining a degree to which a content item is relevant to the at least one characteristic associated with the context information. In some cases, relevancy may be determined by comparing metadata or other tags that may be automatically or manually applied to content items in order to describe or in some way identify a content item at the time of content creation or subsequent thereto. As such, each content item may include one or more metadata tags that may define characteristics or features of the respective content items such that those features or characteristics can be compared to the characteristic determined by the context engine 90. In one alternative, the user may have selected multiple items as reference items and relevance of other content items may be defined relative to the reference of content items.

As an example, a user may review a plurality of content items and select one content item as a reference content item. The reference content item may have metadata indicating that the reference content item was created on a particular date or at a particular location. In one example, other content items may be considered to be relevant to the reference content item based on their proximity to the particular date or location. Alternatively or additionally, the reference content item may be an image, document, video or album having metadata indicating a particular characteristic of the reference content item (e.g., who the picture is of, what event the picture is associated with, the subject or title of the document, the subject, title or creator of the video, the subject, title, creator or genre of the album, etc.). The particular characteristic may be compared to corresponding characteristics of other content items to determine a corresponding one or more relevancies the corresponding content items may share with the reference content item. In some cases, the actual content of the reference content item may be analyzed (e.g., using facial recognition, object recognition or other image analysis techniques for images, using textual parsing for documents, and/or the like). Although in some cases, items that have relevance to a certain selected item each be the same type (for example only images), other embodiments may allow relevant items to include different content types (like photos, messages, documents, etc.).

After relevant content items have been identified (based on a degree of similarity or relevance) by the relevance engine 88, the relevant (and/or irrelevant) content items may be presented to the user in a manner that indicates the corresponding relevance (or irrelevance) and perhaps also indicates a degree of the relevance (or irrelevance). The presentation of the content items may be accomplished by the display manager 84. The display manager 84 may present relevant content items according to a selected presentation paradigm. The selected presentation paradigm may be set by user preference or indicated specifically by the user at the time that the touch event for initiating example embodiments is undertaken. Some examples of selected presentation paradigms that may be employed by the display manager 84 are described below.

In an example embodiment, the display manager 84 may employ uneven zooming to identify content items based on their relevance to the reference content item or items. In some cases, the uneven zooming may include the zooming in on content items that are considered relevant and/or zooming out on content items that are considered irrelevant. In some cases, the uneven zooming may apply to certain items in that no zooming is applied to those corresponding certain items. In an example embodiment, the degree of zooming applied to each content item may be based on (or proportional to) the degree of relevance of the respective content item to the reference content item. Thus, for example, in some cases a group of images could be zoomed to different sizes in order of relevance. Furthermore, in some cases, the least relevant images may be eliminated or be moved behind other images.

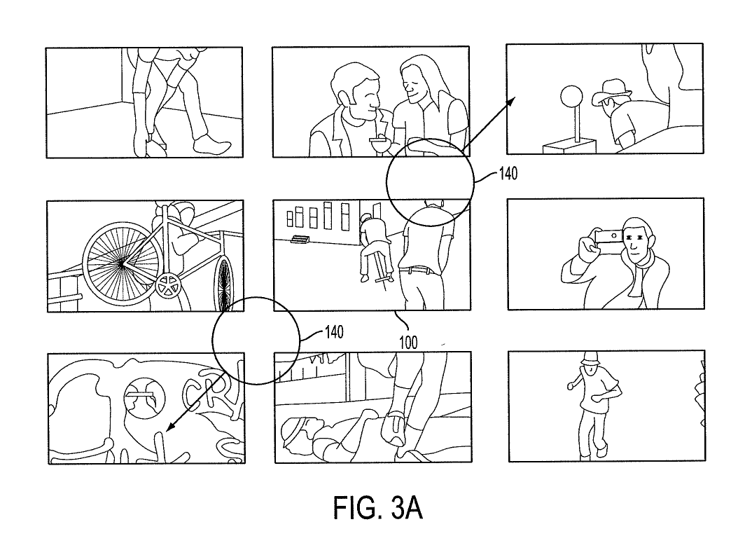

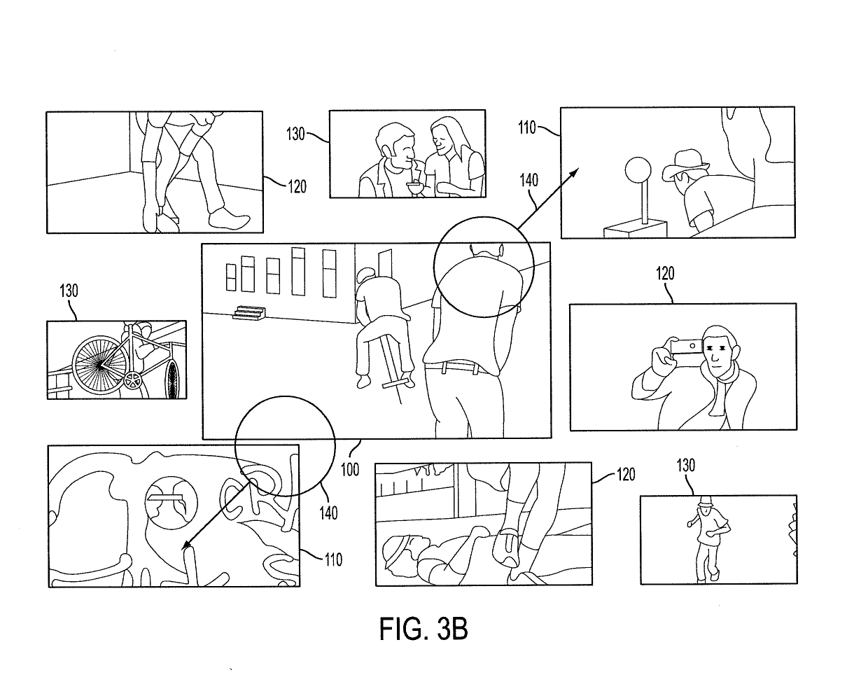

FIG. 3, which includes FIGS. 3A and 3B, illustrates an example of uneven zooming as a selected presentation paradigm. FIG. 3A illustrates an initial state and user action requesting presentation of content items according to the selected presentation paradigm and FIG. 3B illustrates the presentation of the content items with uneven zooming. As shown in FIG. 3A, a plurality of content items may initially be presented on the display. The user may then select one of the content items as a reference content item 100. However, it should be appreciated that, in some cases, example embodiments may be practiced without identification of a specific content item as a reference item. For example, relevant items may simply be determined based on context of the user without identifying a specific reference content item. Regardless of whether a reference content item is associated with or identified by a touch gesture initiated by the user, context information may then (i.e., responsive to the touch gesture) be determined in order to find a characteristic (or characteristics) upon which to base relevancy determinations. The other content items may be ranked or scored based on their relevancy and uneven zooming may be applied to the content items as shown in FIG. 3B. In this regard, the reference content item 100 may be zoomed in the most and other highly relevant content items 110 may be zoomed in to a lesser degree. Some content items that are moderately relevant 120 may not be zoomed (or may be zoomed in to a lesser degree), while irrelevant content items 130 may be zoomed out (or may even disappear in some cases). In some example embodiments, sizes of images may not be changed, but certain images may move behind each other or certain images may become visible as described in greater detail below.

In an example embodiment, the user may be viewing the images of FIG. 3A with a friend (e.g., John). Alternatively, the user may be chatting or may have recently finished chatting with John, may have shared content with John, may be on his way to visit John or near John's house, or may be near a device associated with John. Under any of the above circumstances, the context engine 90 may determine context information that associates with John as a likely subject of interest to the user under the current circumstances. In other words, the context engine 90 may determine that the current disposition of the user is that the user is predisposed to have a likelihood of interest in content associated with John. In some embodiments, the user may even enter (verbally or via text) “John” as context information, or may specify the context in more detail (e.g., pictures of John, or pictures of me and John, etc.)

In response to affecting a touch event (e.g., a pinch event (pinch out in this case as shown by arrows 140) or any other touch event that may indicate a desire to zoom on selected content or otherwise initiate an example embodiment), the plurality of content items may be reviewed for their relevancy to the subject of John. In some cases, images associated with or relevant to John may be zoomed in based on their relevancy. For example, images of John, images that include the user and John, or images taken by John may be considered to be relevant and may therefore be zoomed in on the display of FIG. 3B.

As indicated above, images with pictures of certain persons (or combinations of person) or images taken by certain persons may be considered more relevant than others (e.g., based on metadata or face recognition). Images of or taken from certain locations may have greater relevance, or even images with similar quality conditions may have greater relevance. The user may define preferences for relevance determinations or may provide relevance feedback that may be used to learn user habits or preferences to improve relevance determinations on an ongoing basis.

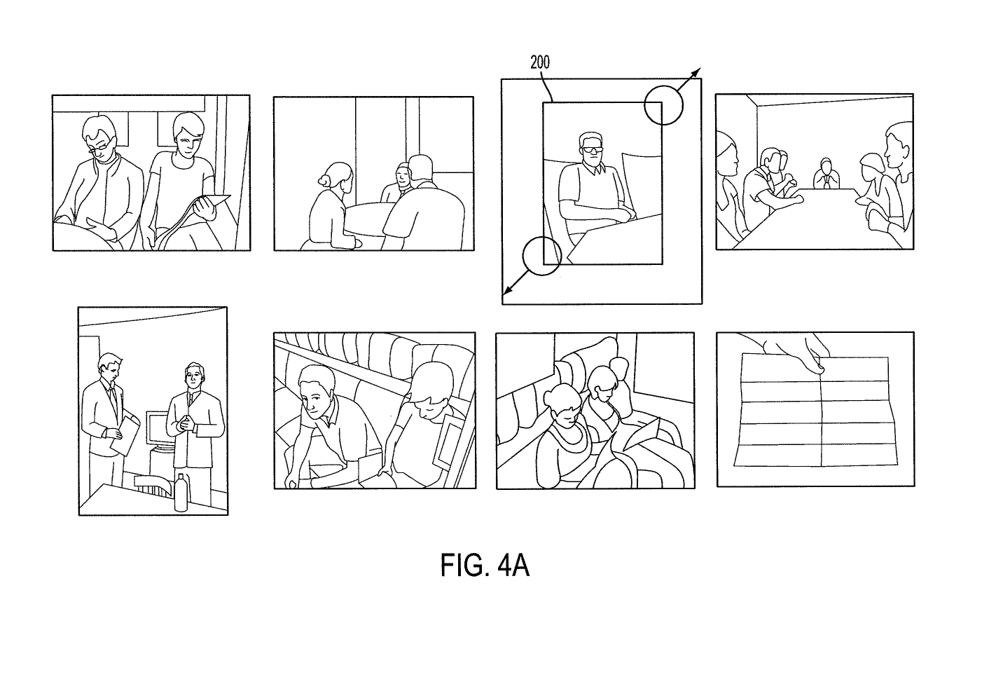

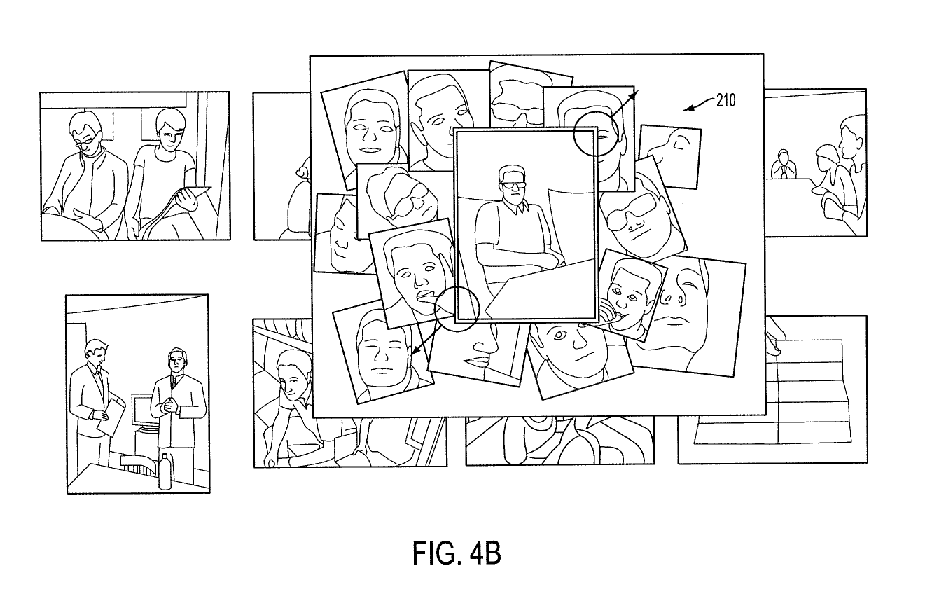

FIG. 4, which includes FIGS. 4A and 4B, illustrates an alternative embodiment in which relevant images to the reference content item may be presented or revealed in proximity to the reference content item in response to the touch event selecting the reference content item. In some cases, the relevant content items may be presented in a collage of selectable content items displayed all around the reference content item. Any other form of displaying relevant content items is also possible. As shown in FIG. 4A, a plurality of images may initially be presented. However, it should be appreciated that in some cases there may only be a single image in a particular image folder. In response to the user performing a touch event (e.g., a pinch out in this example) with respect to one of the images (e.g., reference image 200), a collage of images 210 relevant to the reference image 200 may be presented behind or in the background with respect to the reference image 200 as shown in FIG. 4B. In some cases, the collage of images 210 may simply overlay over the top of the other images. However, the other images could be eliminated and/or replaced by the collage of images 210. As an example, the reference image 200 may be of a particular individual and the collage of images 210 may then represent other images relevant to the particular individual (e.g., based on metadata or facial recognition). Additionally, in this example, appearing images (or contact cards or any other type of content items) may have different sizes based on whether they are to some extent relevant or very relevant, etc.

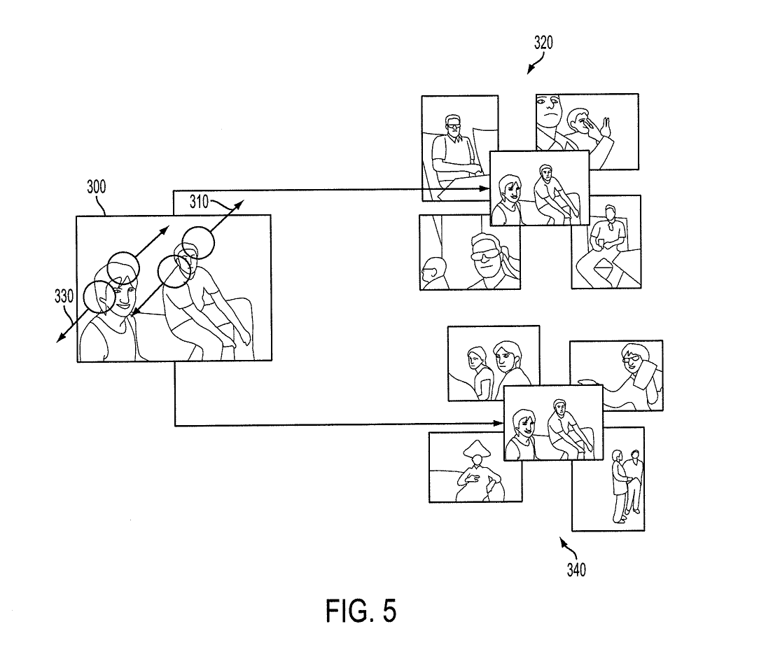

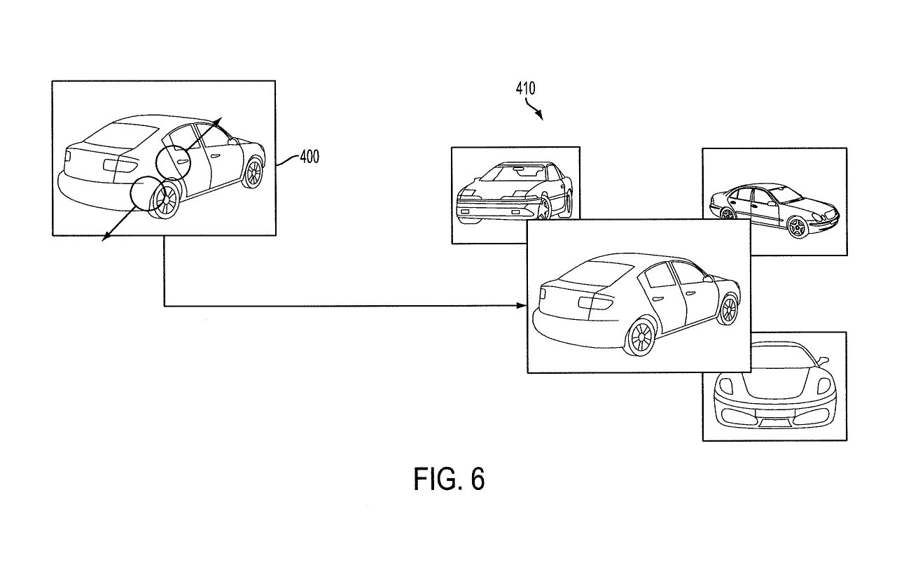

In some embodiments, the user may simply be viewing an image and may perform a touch event on a specific portion or object of the image (e.g., on the face of a user or on a specific object). The specific portion of the object or image may then be used to further define context information for the establishment of a characteristic or characteristics to form the basis for relevancy determinations. FIG. 5 shows a reference image 300 having two different individuals therein. In response to selection of one of the individuals (as indicated by pinch out arrows 310), a first collage 320 may be presented with images relevant to the selected individual. However, in response to selection of the other one of the individuals (as indicated by pinch out arrows 330), a second collage 340 may be presented with images relevant to the corresponding selection of the other individual. Similarly, as shown in FIG. 6, selection of an object (e.g., a red car) in a reference image 400 may provide for presentation of a collage 410 including other images of red cars. In some examples, the user may first make a pinch gesture for one item on the image to get relevant images and then make a pinch gesture for another item (or items) in the same image to further sort the relevant images (e.g., to get relevant images for both Ferrari and a friend named John on the image)

It should be appreciated that although FIGS. 3-6 each illustrate an example embodiment in the context of content items that are images, example embodiments may be practiced in connection with any type of content items. For example, if a group of music items or videos are presented (e.g., either albums or specific music files, movies or video clips), the user may perform a touch event to select one of the music items or video items. File representations or movie/album covers of relevant music items or video items to the selected item (e.g., the reference music item or video item) may be zoomed in to a greater degree or presented in a collage as described above. The relevant music items or video items may be determined based on frequency of play (or infrequency of play), artist, director, actor/actress, title, genre, most recently played content, or any other suitable characteristics. Example embodiments may also apply to other items like folders, files, icons etc.

As another example of a type of content item that could be used in connection with example embodiments, documents could be the subject of a touch event initiating an example embodiment. Characteristics such as frequency (or infrequency) of access, author, most recently opened content, content associated with a particular location, task, application or person, etc., may form the basis for relevancy determinations. File representations of relevant documents to a reference document may be zoomed in based on their relevance or may be presented in a collage as described above.

Messages and/or social activity may also be treated in a similar fashion. For example, relevant messages may be zoomed in or presented in a collage. The determination of relevance may be based on whether messages have been read, message sender, message content, message type, or any of numerous other criteria.

In some embodiments, there may be different sources for relevance content and the content may be shown in different phases. For example, if a pinch gesture is received in association with a musical content item such as song A, an example embodiment may first show relevant items to song A that are located in user's device and then, in a next phase, show songs of the user that are located in a cloud library (e.g., not in user device). In yet a further phase, if the user continues making pinch gestures, an example embodiment may reveal songs from the user's friends that are relevant to song A. In still another later phase, an example embodiment may reveal relevant images that are found from a common music library, etc. In other words, some example embodiments may be configured to utilize different sources of relevant data based on how much pinching the user does for a particular object.

Accordingly, some example embodiments of the present invention may provide ways to present relevant content items to a particular reference item selected at a touch screen display. The reference item may be selected by any particular touch event that may be associated with selection of a content item with the intent of identifying content that is relevant to the selected content item. In some cases, the touch event may be a pinch event such as a pinch out event that may identify an intent to zoom out on a content item or select it for presentation of corresponding other relevant content.

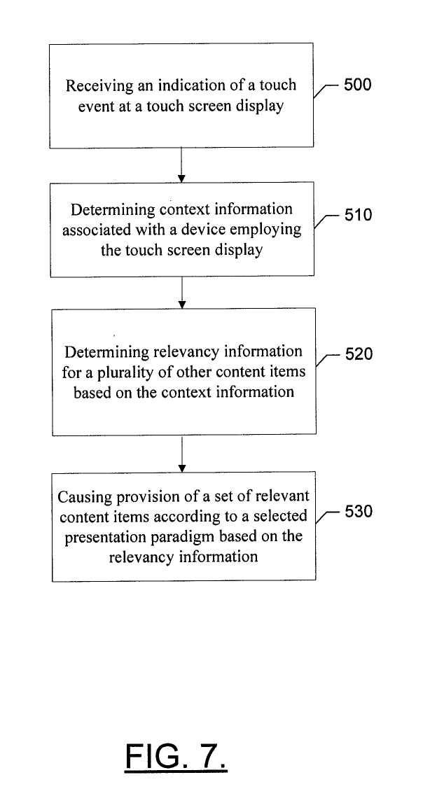

FIG. 7 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (either mobile or fixed) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 7, may include receiving an indication of a touch event at a touch screen display identifying a reference content item at operation 500 and determining context information associated with the reference content item at operation 510. The method may further include determining relevancy information for a plurality of other content items based on the context information at operation 520 and causing provision of a set of relevant content items according to a selected presentation paradigm based on the relevancy information at operation 530.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, causing provision of the set of relevant content items according to the selected presentation paradigm may include causing presentation of a zoomed in view of the relevant content items. Irrelevant content may be zoomed out and/or eliminated depending upon a degree of the determined irrelevance. In some embodiments, causing provision of the set of relevant content items according to the selected presentation paradigm may include causing presentation of a zoomed in view of the relevant content items with an amount of zooming for each respective content item displayed being determined based on the relevancy information. In an example embodiment, causing provision of the set of relevant content items according to the selected presentation paradigm may include presenting the set of relevant content items as a collage of selectable items positioned proximate to the reference content item. In some cases, receiving the indication of the touch event may include receiving a pinch event in association with the reference content item. In an example embodiment, determining context information may include determining a characteristic of the reference content item that correlates to a corresponding characteristic associated with a current disposition of a user of the touch screen display. In some examples, determining relevancy information may include determining a degree to which a content item is relevant to the characteristic.

In an example embodiment, an apparatus for performing the method of FIG. 7 above may comprise a processor (e.g., the processor 70) configured to perform some or each of the operations (500-530) described above. The processor 70 may, for example, be configured to perform the operations (500-530) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-530 may comprise, for example, the touch screen interface 80 (or respective different components thereof). Additionally or alternatively, at least by virtue of the fact that the processor 70 may be configured to control or even be embodied as the touch screen interface 80, the processor 70 and/or a device or circuitry for executing instructions or executing an algorithm for processing information as described above may also form example means for performing operations 500-530.

An example of an apparatus according to an example embodiment may include at least one processor and at least one memory including computer program code. The at least one memory and the computer program code may be configured to, with the at least one processor, cause the apparatus to perform the operations 500-530 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 500-530 (with or without the modifications and amplifications described above in any combination).

In some cases, the operations (500-530) described above, along with any of the modifications may be implemented in a method that involves facilitating access to at least one interface to allow access to at least one service via at least one network. In such cases, the at least one service may be said to perform at least operations 500 to 530.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a touch event at a touch screen display;
determining context information associated with a device employing the touch screen display;
determining relevancy information for a plurality of content items based on the context information; and
causing provision of a set of relevant content items according to a selected presentation paradigm based on the relevancy information.

2. The method of claim 1, wherein causing provision of the set of relevant content items according to the selected presentation paradigm comprises causing presentation of a zoomed in view of the relevant content items.

3. The method of claim 1, wherein causing provision of the set of relevant content items according to the selected presentation paradigm comprises causing presentation of a zoomed in view of the relevant content items with an amount of zooming for each respective content item displayed being determined based on the relevancy information.

4. The method of claim 1, wherein causing provision of the set of relevant content items according to the selected presentation paradigm comprises causing presentation of a zoomed in view of the relevant content items and a zoomed out view of irrelevant content items.

5. The method of claim 1, wherein receiving an indication of the touch event comprises receiving an indication identifying a reference content item, and wherein determining the context information comprises determining context information associated with the reference content item.

6. The method of claim 5, wherein causing provision of the set of relevant content items according to the selected presentation paradigm comprises presenting the set of relevant content items as a collage of selectable items positioned proximate to the reference content item.

7. The method of claim 5, wherein receiving the indication of the touch event comprises receiving a pinch event in association with the reference content item.

8. The method of claim 5, wherein determining context information comprises determining a characteristic of the reference content item that correlates to a corresponding characteristic associated with a current disposition of a user of the touch screen display.

9. An apparatus comprising at least one processor and at least one memory including computer program code, the at least one memory and the computer program code configured to, with the processor, cause the apparatus to at least:
receive an indication of a touch event at a touch screen display;
determine context information associated with a device employing the touch screen display;
determine relevancy information for a plurality of content items based on the context information; and
cause provision of a set of relevant content items according to a selected presentation paradigm based on the relevancy information.

10. The apparatus of claim 9, wherein the at least one memory and computer program code are further configured to cause provision of the set of relevant content items according to the selected presentation paradigm by causing presentation of a zoomed in view of the relevant content items.

11. The apparatus of claim 9, wherein the at least one memory and computer program code are further configured to cause provision of the set of relevant content items according to the selected presentation paradigm by causing presentation of a zoomed in view of the relevant content items with an amount of zooming for each respective content item displayed being determined based on the relevancy information.

12. The apparatus of claim 9, wherein the at least one memory and computer program code are further configured to cause provision of the set of relevant content items according to the selected presentation paradigm by causing presentation of a zoomed in view of the relevant content items and a zoomed out view of irrelevant content items.

13. The apparatus of claim 9, wherein the at least one memory and computer program code are further configured to receive an indication of the touch event by receiving an indication identifying a reference content item, and wherein the at least one memory and computer program code are further configured to determine the context information by determining context information associated with the reference content item.

14. The apparatus of claim 13, wherein the at least one memory and computer program code are further configured to cause provision of the set of relevant content items according to the selected presentation paradigm by presenting the set of relevant content items as a collage of selectable items positioned proximate to the reference content item.

15. The apparatus of claim 13, wherein the at least one memory and computer program code are further configured to receive the indication of the touch event by receiving a pinch event in association with the reference content item.

16. The apparatus of claim 13, wherein the at least one memory and computer program code are further configured to determine context information by determining a characteristic of the reference content item that correlates to a corresponding characteristic associated with a current disposition of a user of the touch screen display.

17. A computer program product comprising at least one non-transitory computer-readable storage medium having computer-executable program code instructions stored therein, the computer-executable program code instructions comprising program code instructions to:
receive an indication of a touch event at a touch screen display;
determine context information associated with a device employing the touch screen display;
determine relevancy information for a plurality of content items based on the context information; and
cause provision of a set of relevant content items according to a selected presentation paradigm based on the relevancy information.

18. The computer program product of claim 17, wherein program code instructions for causing provision of the set of relevant content items according to the selected presentation paradigm include instructions for causing presentation of a zoomed in view of the relevant content items.

19. The computer program product of claim 17, wherein program code instructions for causing provision of the set of relevant content items according to the selected presentation paradigm include instructions for causing presentation of a zoomed in view of the relevant content items with an amount of zooming for each respective content item displayed being determined based on the relevancy information.

20. The computer program product of claim 17, wherein program code instructions for causing provision of the set of relevant content items according to the selected presentation paradigm include instructions for causing presentation of a zoomed in view of the relevant content items and a zoomed out view of irrelevant content items.

21. The computer program product of claim 17, wherein program code instructions for receiving an indication of the touch event include instructions for receiving an indication identifying a reference content item, and wherein program code instructions for determining the context information include instructions for determining context information associated with the reference content item.

22. The computer program product of claim 21, wherein program code instructions for causing provision of the set of relevant content items according to the selected presentation paradigm include instructions for presenting the set of relevant content items as a collage of selectable items positioned proximate to the reference content item.

23. The computer program product of claim 21, wherein program code instructions for receiving the indication of the touch event include instructions for receiving a pinch event in association with the reference content item.

24. The computer program product of claim 21, wherein program code instructions for determining context information include instructions for determining a characteristic of the reference content item that correlates to a corresponding characteristic associated with a current disposition of a user of the touch screen display.
